(19) United States
(12) Patent Application Publication
(10) Pub. No.: US 2023/0262807 A1
(43) Pub. Date: Aug. 17, 2023

(54) Link Management for Multi-link Devices

(71) Applicant: Apple Inc., Cupertino, CA (US)

(72) Inventors: Jinjing Jiang, Campbell, CA (US); Jarkko L. Kneckt, Los Gatos, CA (US); Qi Wang, Sunnyvale, CA (US); Yong Liu, Campbell, CA (US); Su Khiong Yong, Palo Alto, CA (US); Tianyu Wu, Fremont, CA (US)

(21) Appl. No.: 18/164,787

(22) Filed: Feb. 6, 2023

Related U.S. Application Data
(60) Provisional application No. 63/310,993, filed on Feb. 16, 2022.

(51) Int. Cl. H04W 76/15; H04W 28/08

(52) U.S. Cl. CPC H04W 76/15; H04W 28/0925

(57) ABSTRACT

Methods, systems and apparatuses for managing load of various traffic flows and various links by an access point (AP) multi-link device (MLD) and non-AP MLD are described. An AP MLD may determine a mapping and a flexible usage policy. The AP MLD may transmit an indication of the flexible usage policy. A non-AP MLD may transmit data to the AP MLD according to the flexible usage policy.

### PRIORITY INFORMATION

This application claims priority to U.S. provisional patent application Ser. No. 63/310,993, entitled “Link management for multi-link devices,” filed Feb. 16, 2022, which is hereby incorporated by reference in its entirety as though fully and completely set forth herein. The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, any disclaimer made in the instant application should not be read into or against the parent application or other related applications.

### FIELD

The present application relates to wireless communications, including techniques for wireless communication among wireless stations and/or access points in a wireless networking system.

### DESCRIPTION OF THE RELATED ART

Wireless communication systems are rapidly growing in usage. Further, wireless communication technology has evolved from voice-only communications to also include the transmission of data, such as Internet and multimedia content. A popular short/intermediate range wireless communication standard is wireless local area network (WLAN). Most modern WLANs are based on the IEEE 802.11 standard (and/or 802.11, for short) and are marketed under the Wi-Fi brand name. WLAN networks link one or more devices to a wireless access point, which in turn provides connectivity to the wider area Internet.

In 802.11 systems, devices that wirelessly connect to each other are referred to as “stations”, “mobile stations”, “user devices”, “user equipment”, or STA or UE for short. Wireless stations can be either wireless access points or wireless clients (and/or mobile stations). Access points (APs), which are also referred to as wireless routers, act as base stations for the wireless network. APs transmit and receive radio frequency signals for communication with wireless client devices. APs may also couple to the Internet in a wired and/or wireless fashion. Wireless clients operating on an 802.11 network can be any of various devices such as laptops, tablet devices, smart phones, smart watches, or fixed devices such as desktop computers. Wireless client devices are referred to herein as user equipment (and/or UE for short). Some wireless client devices are also collectively referred to herein as mobile devices or mobile stations (although, as noted above, wireless client devices overall may be stationary devices as well).

Mobile electronic devices may take the form of smart phones or tablets that a user typically carries. Wearable devices (also referred to as accessory devices) are a newer form of mobile electronic device, one example being smart watches. Additionally, low-cost low-complexity wireless devices intended for stationary or nomadic deployment are also proliferating as part of the developing “Internet of Things”. In other words, there is an increasingly wide range of desired device complexities, capabilities, traffic patterns, and other characteristics.

Some WLANs may utilize multi-link operation (MLO), e.g., using a plurality of channels (e.g., links) concurrently. APs and/or STAs capable of MLO may be referred to as multi-link devices (MLD). For example, APs capable of MLO may be referred to as AP-MLDs and STAs capable of MLO that are not acting as APs may be referred to as non-AP MLDs. Improvements in the field are desired.

### SUMMARY

Embodiments described herein relate to systems, methods, apparatuses, and mechanisms for link management by AP and non-AP MLDs.

An access point (AP) multi-link device (MLD) (AP MLD) may provide a plurality of links. The AP MLD may provide a plurality of links and may establish communication with a non-AP MLD. The communication may be according to a first mapping between a plurality of traffic identifiers (TIDs) and the plurality of links. The first mapping may specify that respective TIDs of the plurality of TIDs are mapped to at least respective subsets of the plurality of links. The AP MLD may transmit, to the non-AP MLD, an indication of a first guideline for use of a first link of the plurality of links. The AP MLD may perform an exchange of data with the non-AP MLD using the first link of the plurality of links. The AP MLD may determine whether the exchange of data is consistent with the first guideline for use of the first link of the plurality of links.

The AP MLD and non-AP MLD may exchange additional messages with additional proposals and information related to flexible link usage. For example, the non-AP MLD may provide an indication of requested usage. The AP MLD may update the flexible link usage from time to time. The AP MLD may determine the non-AP MLD's level of compliance with the flexible link usage guideline(s).

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of the embodiments is considered in conjunction with the following drawings.

FIG. 1 illustrates an example wireless communication system, according to some embodiments.

FIG. 2 illustrates an example simplified block diagram of a wireless device, according to some embodiments.

FIG. 3 illustrates an example WLAN communication system, according to some embodiments.

FIG. 4 illustrates an example simplified block diagram of a WLAN Access Point (AP), according to some embodiments.

FIG. 5 illustrates an example simplified block diagram of a wireless station (STA), according to some embodiments.

FIG. 6 illustrates an example simplified block diagram of a wireless node, according to some embodiments.

FIG. 7 illustrates an example of an AP MLD, according to some embodiments.

FIG. 8 illustrates an example of two MLDs in communication, according to some embodiments.

FIGS. 9-11 illustrate example mappings, according to some embodiments.

FIG. 12 illustrates an example method of load balancing between links by MLDs, according to some embodiments.

FIG. 13 illustrates an example method of indicating requested usage, according to some embodiments.

FIG. 14 illustrates an example of a flexible mapping, according to some embodiments.

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present application. Definitions of the most prominently used acronyms that may appear throughout the present application are provided below:

UE: User Equipment

AP: Access Point

STA: Wireless Station

TX: Transmission/Transmit

RX: Reception/Receive

MLD: Multi-link Device

LAN: Local Area Network

WLAN: Wireless LAN

RAT: Radio Access Technology

QoS: Quality of Service

### Terminology

The following is a glossary of terms used in this disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (and/or combination of devices) having at least one processor that executes instructions from a memory medium.

Mobile Device (and/or Mobile Station)—any of various types of computer systems devices which are mobile or portable and which performs wireless communications using WLAN communication. Examples of mobile devices include mobile telephones or smart phones (e.g., iPhone™, Android™-based phones), and tablet computers such as iPad™, Samsung Galaxy™, etc. Various other types of devices would fall into this category if they include Wi-Fi or both cellular and Wi-Fi communication capabilities, such as laptop computers (e.g., MacBook™), portable gaming devices (e.g., Nintendo DS™, PlayStation Portable™, Gameboy Advance™, iPhone™), portable Internet devices, and other handheld devices, as well as wearable devices such as smart watches, smart glasses, headphones, pendants, earpieces, etc. In general, the term “mobile device” can be broadly defined to encompass any electronic, computing, and/or telecommunications device (and/or combination of devices) which is easily transported by a user and capable of wireless communication using WLAN or Wi-Fi.

Wireless Device (and/or Wireless Station)—any of various types of computer systems devices which performs wireless communications using WLAN communications. As used herein, the term “wireless device” may refer to a mobile device, as defined above, or to a stationary device, such as a stationary wireless client or a wireless base station. For example, a wireless device may be any type of wireless station of an 802.11 system, such as an access point (AP) or a client station (STA or UE). Further examples include televisions, media players (e.g., AppleTV™, Roku™, Amazon FireTV™, Google Chromecast™, etc.), refrigerators, laundry machines, thermostats, and so forth.

WLAN—The term “WLAN” has the full breadth of its ordinary meaning, and at least includes a wireless communication network or RAT that is serviced by WLAN access points and which provides connectivity through these access points to the Internet. Most modern WLANs are based on IEEE 802.11 standards and are marketed under the name “Wi-Fi”. A WLAN network is different from a cellular network.

Processing Element—refers to various implementations of digital circuitry that perform a function in a computer system. Additionally, processing element may refer to various implementations of analog or mixed-signal (combination of analog and digital) circuitry that perform a function (and/or functions) in a computer or computer system. Processing elements include, for example, circuits such as an integrated circuit (IC), ASIC (Application Specific Integrated Circuit), portions or circuits of individual processor cores, entire processor cores, individual processors, programmable hardware devices such as a field programmable gate array (FPGA), and/or larger portions of systems that include multiple processors.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, e.g., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Concurrent—refers to parallel execution or performance, where tasks, processes, signaling, messaging, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

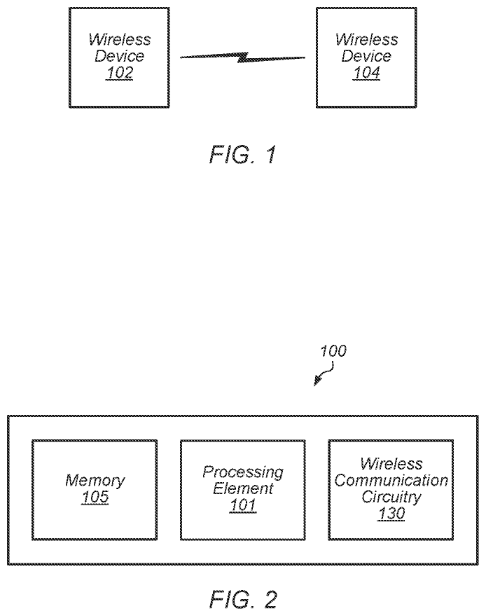

### FIGS. 1-2—Wireless Communication System

FIG. 1 illustrates an exemplary (and simplified) wireless communication system in which aspects of this disclosure may be implemented. It is noted that the system of FIG. 1 is merely one example of a possible system, and embodiments of this disclosure may be implemented in any of various systems, as desired.

As shown, the exemplary wireless communication system includes a (“first”) wireless device 102 in communication with another (“second”) wireless device. The first wireless device 102 and the second wireless device 104 may communicate wirelessly using any of a variety of wireless communication techniques, potentially including ranging wireless communication techniques.

As one possibility, the first wireless device 102 and the second wireless device 104 may perform ranging using wireless local area networking (WLAN) communication technology (e.g., IEEE 802.11/Wi-Fi based communication) and/or techniques based on WLAN wireless communication. One or both of the wireless device 102 and the wireless device 104 may also be capable of communicating via one or more additional wireless communication protocols, such as any of Bluetooth (BT), Bluetooth Low Energy (BLE), near field communication (NFC), GSM, UMTS (WCDMA, TDSCDMA), LTE, LTE-Advanced (LTE-A), NR, 3GPP2 CDMA2000 (e.g., 1×RTT, 1×EV-DO, HRPD, eHRPD), Wi-MAX, GPS, etc.

The wireless devices 102 and 104 may be any of a variety of types of wireless device. As one possibility, one or more of the wireless devices 102 and/or 104 may be a substantially portable wireless user equipment (UE) device, such as a smart phone, handheld device, a wearable device such as a smart watch, a tablet, a motor vehicle, or virtually any type of wireless device. As another possibility, one or more of the wireless devices 102 and/or 104 may be a substantially stationary device, such as a set top box, media player (e.g., an audio or audiovisual device), gaming console, desktop computer, appliance, door, access point, base station, or any of a variety of other device types.

Each of the wireless devices 102 and 104 may include wireless communication circuitry configured to facilitate the performance of wireless communication, which may include various digital and/or analog radio frequency (RF) components, a processor that is configured to execute program instructions stored in memory, a programmable hardware element such as a field-programmable gate array (FPGA), and/or any of various other components. The wireless device 102 and/or the wireless device 104 may perform any of the method embodiments described herein, or any portion of any of the method embodiments described herein, using any or all of such components.

Each of the wireless devices 102 and 104 may include one or more antennas for communicating using one or more wireless communication protocols. In some cases, one or more parts of a receive and/or transmit chain may be shared between multiple wireless communication standards; for example, a device might be configured to communicate using either of Bluetooth or Wi-Fi using partially or entirely shared wireless communication circuitry (e.g., using a shared radio or at least shared radio components). The shared communication circuitry may include a single antenna, or may include multiple antennas (e.g., for MIMO) for performing wireless communications. Alternatively, a device may include separate transmit and/or receive chains (e.g., including separate antennas and other radio components) for each wireless communication protocol with which it is configured to communicate. As a further possibility, a device may include one or more radios or radio components which are shared between multiple wireless communication protocols, and one or more radios or radio components which are used exclusively by a single wireless communication protocol. For example, a device might include a shared radio for communicating using one or more of LTE, CDMA2000 1×RTT, GSM, and/or 5G NR, and separate radios for communicating using each of Wi-Fi and Bluetooth. Other configurations are also possible.

As previously noted, aspects of this disclosure may be implemented in conjunction with the wireless communication system of FIG. 1. For example, a wireless device (e.g., either of wireless devices 102 or 104) may be configured to perform methods for robust discovery of a new access point (AP) in AP MLD, robust link addition to an AP MLD association, AP beaconing modes when the AP is added or deleted to/from an AP MLD, and robust BSS transition management (BTM) signaling to steer a non-AP MLD to a best AP MLD and to most suitable APs, as well as privacy improvements for associated non-AP MLD.

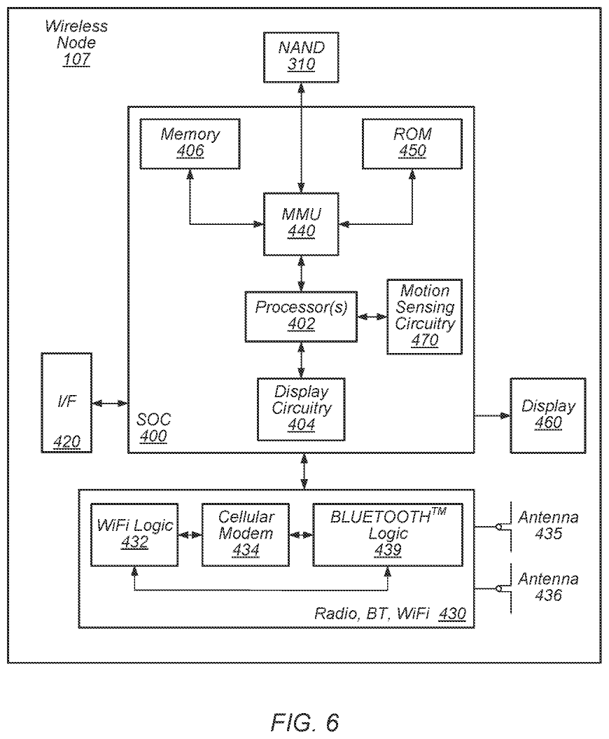

FIG. 6 illustrates an exemplary wireless device 100 (e.g., corresponding to wireless devices 102 and/or 104) that may be configured for use in conjunction with various aspects of the present disclosure. The device 100 may be any of a variety of types of device and may be configured to perform any of a variety of types of functionality. The device 100 may be a substantially portable device or may be a substantially stationary device, potentially including any of a variety of device types. The device 100 may be configured to perform one or more ranging wireless communication techniques or features, such as any of the techniques or features illustrated and/or described subsequently herein with respect to any or all of the Figures.

As shown, the device 100 may include a processing element 101. The processing element may include or be coupled to one or more memory elements. For example, the device 100 may include one or more memory media (e.g., memory 105), which may include any of a variety of types of memory and may serve any of a variety of functions. For example, memory 105 could be RAM serving as a system memory for processing element 101. Other types and functions are also possible.

Additionally, the device 100 may include wireless communication circuitry 130. The wireless communication circuitry may include any of a variety of communication elements (e.g., antenna(s) for wireless communication, analog and/or digital communication circuitry/controllers, etc.) and may enable the device to wirelessly communicate using one or more wireless communication protocols.

Note that in some cases, the wireless communication circuitry 130 may include its own processing element (e.g., a baseband processor), e.g., in addition to the processing element 101. For example, the processing element 101 may be an ‘application processor’ whose primary function may be to support application layer operations in the device 100, while the wireless communication circuitry 130 may be a ‘baseband processor’ whose primary function may be to support baseband layer operations (e.g., to facilitate wireless communication between the device 100 and other devices) in the device 100. In other words, in some cases the device 100 may include multiple processing elements (e.g., may be a multi-processor device). Other configurations (e.g., instead of or in addition to an application processor/baseband processor configuration) utilizing a multi-processor architecture are also possible.

The device 100 may additionally include any of a variety of other components (not shown) for implementing device functionality, depending on the intended functionality of the device 100, which may include further processing and/or memory elements (e.g., audio processing circuitry), one or more power supply elements (which may rely on battery power and/or an external power source) user interface elements (e.g., display, speaker, microphone, camera, keyboard, mouse, touchscreen, etc.), and/or any of various other components.

The components of the device 100, such as processing element 101, memory 105, and wireless communication circuitry 130, may be operatively coupled via one or more interconnection interfaces, which may include any of a variety of interface types, possibly including a combination of multiple interface types. As one example, a USB high-speed inter-chip (HSIC) interface may be provided for inter-chip communications between processing elements. Alternatively (and/or in addition), a universal asynchronous receiver transmitter (UART) interface, a serial peripheral interface (SPI), inter-integrated circuit (I2C), system management bus (SMBus), and/or any of a variety of other communication interfaces may be used for communications between various device components. Other types of interfaces (e.g., intra-chip interfaces for communication within processing element 101, peripheral interfaces for communication with peripheral components within or external to device 100, etc.) may also be provided as part of device 100.

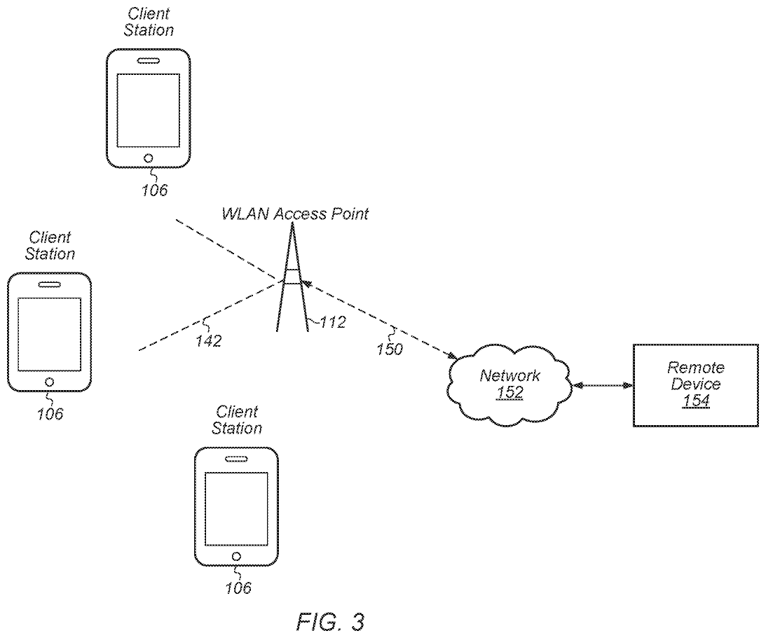

### FIG. 3—WLAN System

FIG. 3 illustrates an example WLAN system according to some embodiments. As shown, the exemplary WLAN system includes a plurality of wireless client stations or devices (e.g., STAs or user equipment (UEs)), 106 that are configured to communicate over a wireless communication channel 142 with an Access Point (AP) 112. The AP 112 may be a Wi-Fi access point. The AP 112 may communicate via a wired and/or a wireless communication channel 150 with one or more other electronic devices (not shown) and/or another network 152, such as the Internet. Additional electronic devices, such as the remote device 154, may communicate with components of the WLAN system via the network 152. For example, the remote device 154 may be another wireless client station, a server associated with an application executing on one of the STAs 106, etc. The WLAN system may be configured to operate according to any of various communications standards, such as the various IEEE 802.11 standards. In some embodiments, at least one wireless device 106 is configured to communicate directly with one or more neighboring mobile devices, without use of the access point 112.

Further, in some embodiments, a wireless device 106 (which may be an exemplary implementation of device 100) may be configured to perform methods for robust discovery of a new access point (AP) in AP MLD, robust link addition to an AP MLD association, AP beaconing modes when the AP is added or deleted to/from an AP MLD, and robust BSS transition management (BTM) signaling to steer a non-AP MLD to a best AP MLD and to most suitable APs, as well as privacy improvements for associated non-AP MLD.

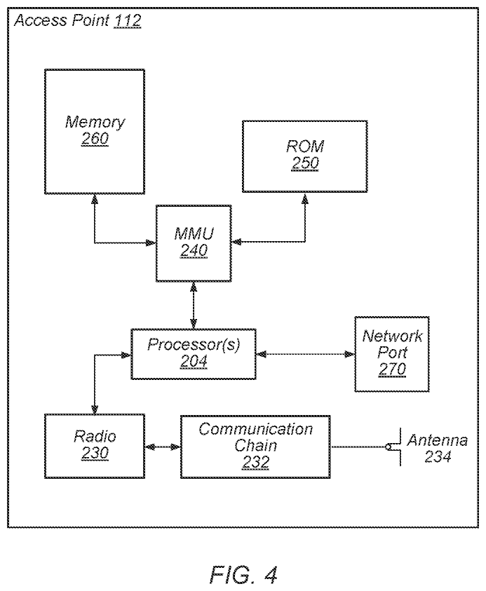

### FIG. 4—Access Point Block Diagram

FIG. 4 illustrates an exemplary block diagram of an access point (AP) 112, which may be one possible exemplary implementation of the device 100 illustrated in FIG. 4. It is noted that the block diagram of the AP of FIG. 4 is only one example of a possible system. As shown, the AP 112 may include processor(s) 204 which may execute program instructions for the AP 112. The processor(s) 204 may also be coupled (directly or indirectly) to memory management unit (MMU) 240, which may be configured to receive addresses from the processor(s) 204 and to translate those addresses to locations in memory (e.g., memory 260 and read only memory (ROM) 250) or to other circuits or devices.

The AP 112 may include at least one network port 270. The network port 270 may be configured to couple to a wired network and provide a plurality of devices, such as mobile devices 106, access to the Internet. For example, the network port 270 (and/or an additional network port) may be configured to couple to a local network, such as a home network or an enterprise network. For example, port 270 may be an Ethernet port. The local network may provide connectivity to additional networks, such as the Internet.

The AP 112 may include at least one antenna 234, which may be configured to operate as a wireless transceiver and may be further configured to communicate with mobile device 106 via wireless communication circuitry 230. The antenna 234 communicates with the wireless communication circuitry 230 via communication chain 232. Communication chain 232 may include one or more receive chains, one or more transmit chains or both. The wireless communication circuitry 230 may be configured to communicate via Wi-Fi or WLAN, e.g., 802.11. The wireless communication circuitry 230 may also, or alternatively, be configured to communicate via various other wireless communication technologies, including, but not limited to, Long-Term Evolution (LTE), LTE Advanced (LTE-A), Global System for Mobile (GSM), Wideband Code Division Multiple Access (WCDMA), CDMA2000, etc., for example when the AP is co-located with a base station in case of a small cell, or in other instances when it may be desirable for the AP 112 to communicate via various different wireless communication technologies.

Further, in some embodiments, as further described below, AP 112 may be configured to perform methods for robust discovery of a new access point (AP) in AP MLD, robust link addition to an AP MLD association, AP beaconing modes when the AP is added or deleted to/from an AP MLD, and robust BSS transition management (BTM) signaling to steer a non-AP MLD to a best AP MLD and to most suitable APs, as well as privacy improvements for associated non-AP MLD.

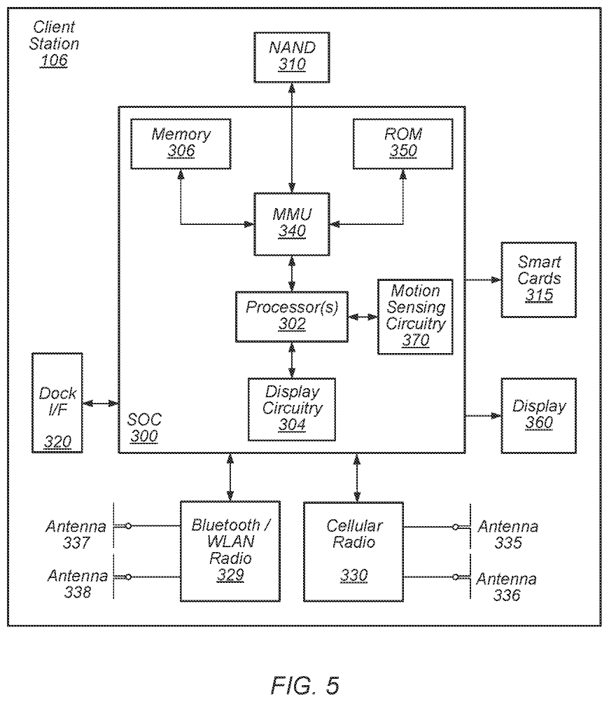

### FIG. 5—Client Station Block Diagram

FIG. 5 illustrates an example simplified block diagram of a client station 106, which may be one possible exemplary implementation of the device 100 illustrated in FIG. 4. According to embodiments, client station 106 may be a user equipment (UE) device, a mobile device or mobile station, and/or a wireless device or wireless station. As shown, the client station 106 may include a system on chip (SOC) 300, which may include portions for various purposes. The SOC 300 may be coupled to various other circuits of the client station 106. For example, the client station 106 may include various types of memory (e.g., including NAND flash 310), a connector interface (I/F) (and/or dock) 320 (e.g., for coupling to a computer system, dock, charging station, etc.), the display 360, cellular communication circuitry (e.g., cellular radio) 330 such as for 5G NR, LTE, GSM, etc., and short to medium range wireless communication circuitry (e.g., Bluetooth™/WLAN radio) 329 (e.g., Bluetooth™ and WLAN circuitry). The client station 106 may further include one or more smart cards 315 that incorporate SIM (Subscriber Identity Module) functionality, such as one or more UICC(s) (Universal Integrated Circuit Card(s)). The cellular communication circuitry 330 may couple to one or more antennas, such as antennas 335 and 336 as shown. The short to medium range wireless communication circuitry 329 may also couple to one or more antennas, such as antennas 337 and 338 as shown. Alternatively, the short to medium range wireless communication circuitry 329 may couple to the antennas 335 and 336 in addition to, or instead of, coupling to the antennas 337 and 338. The short to medium range wireless communication circuitry 329 may include multiple receive chains and/or multiple transmit chains for receiving and/or transmitting multiple spatial streams, such as in a multiple-input multiple output (MIMO) configuration. Some or all components of the short to medium range wireless communication circuitry 329 and/or the cellular communication circuitry 330 may be used for ranging communications, e.g., using WLAN, Bluetooth, and/or cellular communications.

As shown, the SOC 300 may include processor(s) 302, which may execute program instructions for the client station 106 and display circuitry 304, which may perform graphics processing and provide display signals to the display 360. The SOC 300 may also include motion sensing circuitry 370 which may detect motion of the client station 106, for example using a gyroscope, accelerometer, and/or any of various other motion sensing components. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, cellular communication circuitry 330, short range wireless communication circuitry 329, connector interface (I/F) 320, and/or display 360. The MMU 340 may be configured to perform memory protection and page table translation or set up. In some embodiments, the MMU 340 may be included as a portion of the processor(s) 302.

As noted above, the client station 106 may be configured to communicate wirelessly directly with one or more neighboring client stations. The client station 106 may be configured to communicate according to a WLAN RAT for communication in a WLAN network, such as that shown in FIG. 3 or for ranging as shown in FIG. 1.

As described herein, the client station 106 may include hardware and software components for implementing the features described herein. For example, the processor 302 of the client station 106 may be configured to implement part or all of the features described herein, e.g., by executing program instructions stored on a memory medium (e.g., a non-transitory computer-readable memory medium). Alternatively (and/or in addition), processor 302 may be configured as a programmable hardware element, such as an FPGA (Field Programmable Gate Array), or as an ASIC (Application Specific Integrated Circuit). Alternatively (and/or in addition) the processor 302 of the UE 106, in conjunction with one or more of the other components 300, 304, 306, 310, 315, 320,329, 330, 335, 336, 337, 338, 340, 350, 360, 370 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, etc.) configured to perform the functions of processor(s) 204.

Further, as described herein, cellular communication circuitry 330 and short-range wireless communication circuitry 329 may each include one or more processing elements. In other words, one or more processing elements may be included in cellular communication circuitry 330 and also in short range wireless communication circuitry 329. Thus, each of cellular communication circuitry 330 and short-range wireless communication circuitry 329 may include one or more integrated circuits (ICs) that are configured to perform the functions of cellular communication circuitry 330 and short-range wireless communication circuitry 329, respectively. In addition, each integrated circuit may include circuitry (e.g., first circuitry, second circuitry, etc.) configured to perform the functions of cellular communication circuitry 330 and short-range wireless communication circuitry 329.

### FIG. 6—Wireless Node Block Diagram

FIG. 6 illustrates one possible block diagram of a wireless node 107, which may be one possible exemplary implementation of the device 106 illustrated in FIG. 5. As shown, the wireless node 107 may include a system on chip (SOC) 400, which may include portions for various purposes. For example, as shown, the SOC 400 may include processor(s) 402 which may execute program instructions for the wireless node 107, and display circuitry 404 which may perform graphics processing and provide display signals to the display 460. The SOC 400 may also include motion sensing circuitry 470 which may detect motion of the wireless node 107, for example using a gyroscope, accelerometer, and/or any of various other motion sensing components. The processor(s) 402 may also be coupled to memory management unit (MMU) 440, which may be configured to receive addresses from the processor(s) 402 and translate those addresses to locations in memory (e.g., memory 406, read only memory (ROM) 450, flash memory 410). The MMU 440 may be configured to perform memory protection and page table translation or set up. In some embodiments, the MMU 440 may be included as a portion of the processor(s) 402.

As shown, the SOC 400 may be coupled to various other circuits of the wireless node 107. For example, the wireless node 107 may include various types of memory (e.g., including NAND flash 410), a connector interface 420 (e.g., for coupling to a computer system, dock, charging station, etc.), the display 460, and wireless communication circuitry 430 (e.g., for 5G NR, LTE, LTE-A, CDMA2000, Bluetooth, Wi-Fi, NFC, GPS, etc.).

The wireless node 107 may include at least one antenna, and in some embodiments, multiple antennas 435 and 436, for performing wireless communication with base stations and/or other devices. For example, the wireless node 107 may use antennas 435 and 436 to perform the wireless communication. As noted above, the wireless node 107 may in some embodiments be configured to communicate wirelessly using a plurality of wireless communication standards or radio access technologies (RATs).

The wireless communication circuitry 430 may include Wi-Fi Logic 432, a Cellular Modem 434, and Bluetooth Logic 439. The Wi-Fi Logic 432 is for enabling the wireless node 107 to perform Wi-Fi communications, e.g., on an 802.11 network. The Bluetooth Logic 439 is for enabling the wireless node 107 to perform Bluetooth communications. The cellular modem 434 may be capable of performing cellular communication according to one or more cellular communication technologies. Some or all components of the wireless communication circuitry 430 may be used for ranging communications, e.g., using WLAN, Bluetooth, and/or cellular communications.

As described herein, wireless node 107 may include hardware and software components for implementing embodiments of this disclosure. For example, one or more components of the wireless communication circuitry 430 (e.g., Wi-Fi Logic 432) of the wireless node 107 may be configured to implement part or all of the methods described herein, e.g., by a processor executing program instructions stored on a memory medium (e.g., a non-transitory computer-readable memory medium), a processor configured as an FPGA (Field Programmable Gate Array), and/or using dedicated hardware components, which may include an ASIC (Application Specific Integrated Circuit).

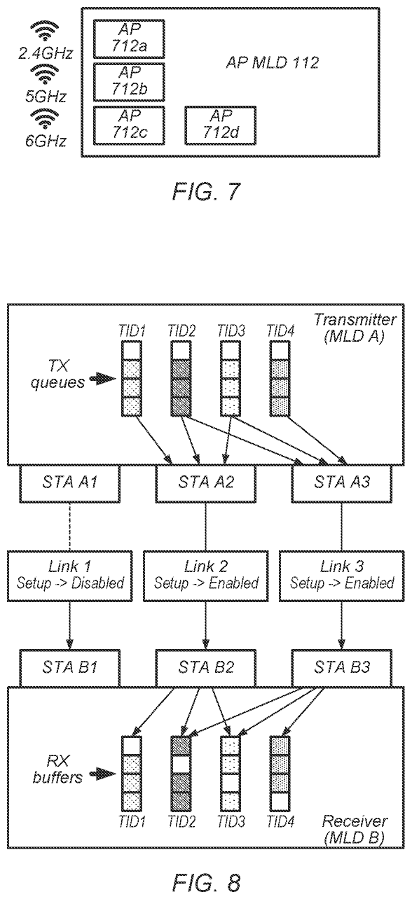

### FIGS. 7-8—Multi-Link Device (MLD) Operation

Various communication standards such as IEEE 802.11be may include Multi-link Device (MLD) capabilities. In current implementations, an access point (AP) Multi Link Device (MLD) node may manage its affiliated APs. Thus, an AP MLD node may modify, add, and/or subtract affiliated APs to increase capacity, manage Basic Service Sets (BSSs) interference and coverage, including switching APs to operate in channels with least interference, and/or steer associated non-AP MLD nodes to operate on best performing APs and/or AP MLD nodes.

FIG. 7 illustrates an AP MLD 112, according to some embodiments. The AP MLD may operate any number of affiliated APs, e.g., APs 712a, 712b, 712c, and 712d in the illustrated example. The affiliated APs may operate on any of various frequency bands. Affiliated APs may operate on different frequency ranges (e.g., channels) of the same band, or on different frequency bands. In the illustrated example, AP 712a may operate in a 2.4 GHz band, AP 712b may operate in a 5 GHz band, and APs 712c and 712d may operate in a 6 GHz band. Other arrangements (e.g., of the same and/or other frequency bands) are possible.

The AP MLD may provide the affiliated APs from a single physical device, e.g., a single shared housing and potentially using the same antenna(s). In some embodiments, the AP MLD may provide the APs from multiple distinct devices (e.g., a first device may provide one or more APs, a second device may provide a different one or more APs, etc.). In some embodiments, various affiliated APs may be separated spatially (e.g., beams in different directions, using different antennas with a shared housing (e.g., antennas of a same physical device), and/or of different devices, etc.).

In some embodiments, spatially separated affiliated APs may operate on a same (or overlapping) channel(s).

FIG. 8 illustrates a transmitting MLD A (e.g., 112 or 106) in communication with a receiving MLD B (e.g., 112 or 106), according to some embodiments. It will be appreciated that although FIG. 8 illustrates transmission in one direction, the MLDs A and B may communicate in both directions, e.g., simultaneously and/or at different times.

As shown, the MLDs may operate multiple (e.g., 3 each, in the illustrated example) affiliated STAs. Corresponding STAs on each MLD may communicate via corresponding links. For example, STA A1 may communicate with STA B1 over link 1, etc.

Data packets/frames of different traffic identifiers (TIDs) may be exchanged over the same and/or different links (e.g., via corresponding STAs). The transmitting and receiving MLDs may buffer the different TIDs separately, e.g., in TX and RX buffers/queues.

The relationship between the TIDs and the links may be referred to as a mapping (e.g., TID-to-link or T2L mapping). As will be appreciated, many mappings are possible, e.g., including one-to-one mappings, one-to-multiple mappings, multiple-to-one mappings, and/or multiple-to-multiple mappings. In the illustrated example, TIDs 1-3 are mapped to link 2 and TIDs 2-4 are mapped to link 3.

A packet (e.g., frame, or other unit of information) may be sent over one or more of the links to which its TID is mapped. For example, a packet of TID 2 may be sent over either or both of link 2 and/or link 3. The transmitting MLD may select one or more of the mapped links based on any of various factors, such as first link available, lowest energy use, highest likelihood of successful reception, channel conditions, input from the receiving MLD, and/or any combination of (e.g., compromise between) these and/or other factors. In some embodiments, a transmitting AP MLD may transmit on all of the mapped links for the TID and a receiving non-AP MLD may receive on any one or more of the mapped links. In some embodiments, a transmitting non-AP MLD may transmit on any one or more of the mapped links for the TID and a receiving non-AP MLD may monitor to potentially receive on all of the mapped links.

A setup link may be considered to be enabled if at least one TID is mapped to that link and may be considered to be disabled if no TIDs are mapped to that link. If a link is enabled, it may be used for frame exchanges, but only limited to the data frames corresponding to the mapped TIDs and management frames. If a link is disabled, it may not be used for frame exchange, including some of the management frame exchange.

A TID may be mapped to at least one setup link, e.g., unless admission control is used.

In some embodiments, TID-to-link mapping may be uni-directional, e.g., TIDs mapped to an uplink (UL) link may not be the same TIDs mapped to the corresponding downlink (DL) link. In some embodiments, the mapping may be bi-directional, e.g., TIDs may be mapped to the same links for DL as for UL and vice versa.

In some embodiments, by default, all TIDs may be mapped to all setup links for both UL and DL. Therefore, all setup links may be enabled. The default TID-to-link mapping mode may be used if: an AP MLD and a non-AP MLD do not negotiate a different mapping; an AP MLD and a non-AP MLD cannot agree on any alternative mapping; or an AP MLD and a non-AP MLD has torn down a previous agreement, e.g., for an alternative mapping.

In some embodiments, TID-to-link mapping negotiation may occur during the multilink (ML) setup process, e.g., via association frames, or via TID-to-link mapping handshakes. For example, either an AP MLD or a non-AP MLD may initiate the negotiation and either an AP MLD or a non-AP MLD may accept or reject a TID-to-link mapping request from a peer. Further, if TID-To-link mapping is not accepted the peer may propose a preferred/alternative mapping.

The affiliated STAs may include various layers, e.g., media access control (MAC) and/or physical (PHY) layers, among various possibilities. Affiliated STAs of an AP MLD may use different basic service sets (BSS) and/or different BSS identifiers (BSSID), e.g., BSSIDs 1-3. It will be appreciated that any number of affiliated STAs may be used in any combination of bands. For example, an MLD may operate multiple affiliated STAs in one band and/or may not operate any affiliated STAs in a band. A non-AP MLD may operate STAs corresponding to some, none, or all of the APs of an AP MLD. The affiliated STAs may use different addresses.

A non-AP MLD may provide the affiliated STAs from a single physical device, e.g., a single shared housing and potentially using the same antenna(s). In some embodiments, the non-AP MLD may provide the STAs from multiple distinct devices (e.g., a first device may provide one or more STAs, a second device may provide a different one or more STAs, etc.). In some embodiments, various affiliated STAs may be separated spatially (e.g., beams in different directions, using different antennas with a shared housing (e.g., antennas of a same physical device), and/or of different devices, etc.).

The various affiliated STAs may communicate concurrently/simultaneously. For example, STA A1 may exchange uplink and/or downlink data with STA B1 on a first link while STA A2 exchanges uplink and/or downlink data with STA B2 on a second link, etc. It will be appreciated that such concurrent communication may include (e.g., different) data being exchanged at the same time, overlapping times, and/or different times on different links. The number of APs and/or number of STAs may change over time.

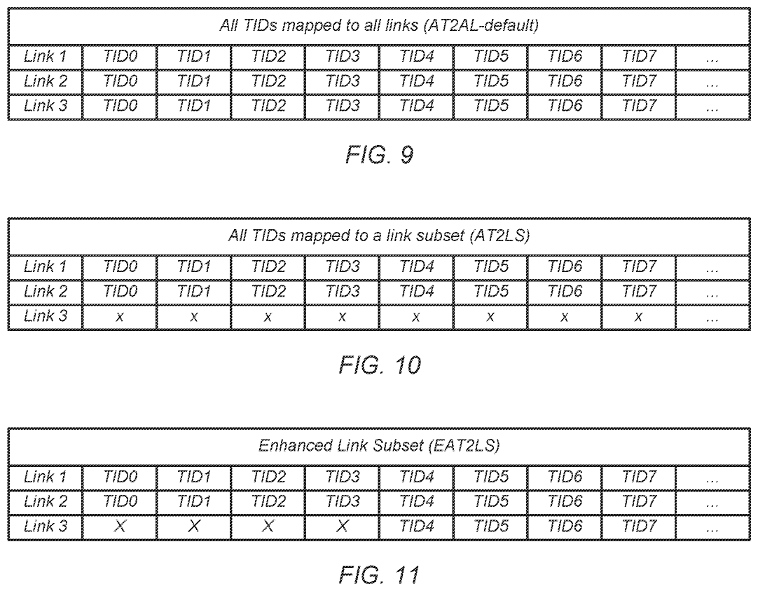

### FIGS. 9-11—Example Mappings

FIGS. 9-11 illustrate examples of various types of mappings. It will be appreciated that an AP MLD may use the same or different mappings (e.g., of the same or different types) with different non-AP MLDs. For example, the AP MLD may use one mapping with a first non-AP MLD and a second mapping with a second non-AP MLD. Different numbers of links and/or TIDs may be used as desired.

FIG. 9 illustrates an example of a type of mapping in which all TIDs are mapped to all links (e.g., an all TIDs to all links (AT2AL) mapping), according to some embodiments. An AT2AL mapping may be used as a default or initial mapping, according to some embodiments. As shown, TIDs 0-7 (and any additional TIDs) are mapped to all links.

An AT2AL mapping may be most flexible to non-AP MLDs. For example, a non-AP MLD may dynamically select whichever link(s) is/are best suitable for DL and UL data communication. However, an AT2AL mapping may be difficult for an AP MLD to balance the traffic loads (e.g., associated with multiple non-AP MLDs) across multiple links. For example, due to different link selections by various non-AP MLDs, some links may be heavily loaded (e.g., at a given time or over an extended period) while other links may be lightly loaded.

FIG. 10 illustrates an example of a type of mapping in which all TIDs are mapped to a (e.g., same) subset of all links (e.g., an all TIDs to link subset (AT2LS) mapping), according to some embodiments. As shown, TIDs 0-7 (and any additional TIDs) are mapped to links 1 and 2; no TIDs are mapped to link 3.

An AT2LS mapping may be good for an AP MLD to balance the traffic loads across multiple links. For example, an AP MLD may move some non-AP MLDs from busy link(s) to idle link(s) by disabling these non-AP MLDs from using the busy link(s), e.g., by moving these non-AP MLDs to AT2LS mappings.

However, an AT2LS mapping may be less flexible to non-AP MLDs. For example, some non-AP MLDs may be assigned to link(s) not suitable to them (e.g., a link with significant coexistence interference). Similarly, with an AT2LS mapping a non-AP MLD may not quickly move high-priority traffic from one link to another link if the assigned link(s) are blocked (e.g., due to changed position of the non-AP MLD or a user, etc.).

FIG. 11 illustrates an example of a type of mapping in which one or more TIDs are mapped to a subset of all links and one or more TIDs are mapped to all links (e.g., an enhanced link subset (EAT2LS) mapping), according to some embodiments. As shown, TIDs 0-3 are mapped to links 1 and 2; TIDs 4-7 are mapped to links 1-3. Any additional TIDs may be mapped to all links or a subset of the links (e.g., the same or potentially a different subset, such as links 1 and 3 (but not link 2), etc.).

An EAT2LS mapping may allow an AP MLD to balance the traffic loads by moving low-priority traffic from busy link(s) to idle link(s). For example, a non-AP MLD using an EAT2LS which prevents the non-AP MLD from using a busy link for low-priority traffic may free up some time/frequency resources on the busy link for high-priority traffic of other non-AP MLDs. Further, an EAT2LS mapping may allow a non-AP MLD to flexibly use all links for high-priority traffic.

It will be appreciated that the mappings illustrated in FIGS. 9-11 are examples and that other mappings are possible. For example, for one non-AP MLD, some TIDs may be mapped to a first subset of links, other TIDs to a second subset (e.g., including, more, fewer, and/or different links), and still other TIDs to all links, etc.

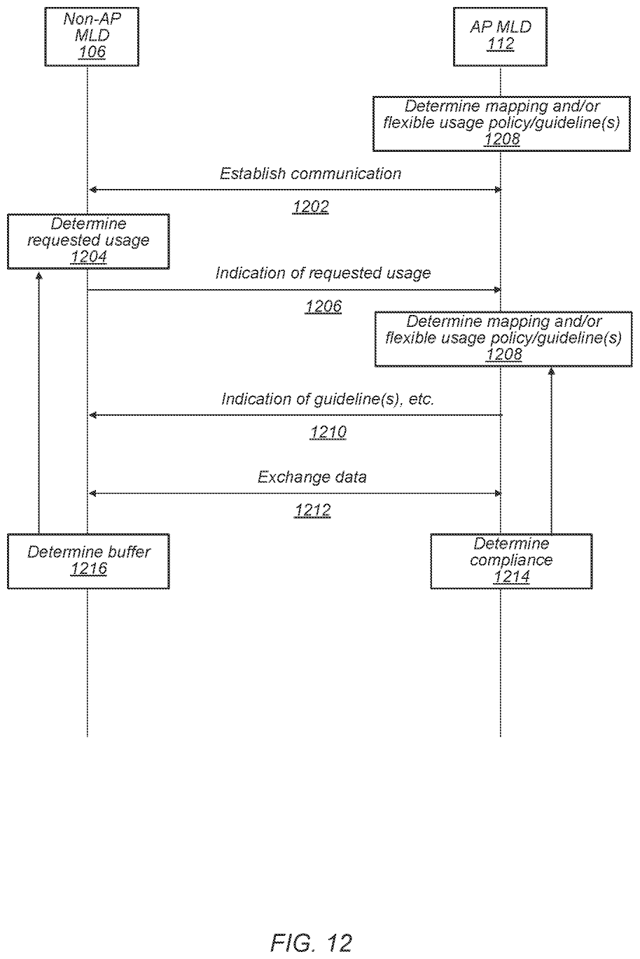

### FIG. 12—Management of Multiple Links

In some embodiments, an-AP MLD may attempt to balance load among various TIDs, links, and STAs (some or all of which may be non-AP MLDs). One option for balancing load may be access control, e.g., restricting what TIDs may be transmitted by what STA/non-AP MLD on what link(s). For example, using TID-to-Link mapping, e.g., as illustrated in FIGS. 9-11, the AP MLD may control the types of traffic that can be sent on the link. Disallowing some types of traffic (e.g., for at least some non-AP MLDs) on a link may reduce the total load on the link. However, the type of traffic is not necessarily a direct indication of the amount of traffic. Thus, such access control may not allow for very precise control of the level of traffic on different links. In other words, access control may allow the AP MLD to control the number of non-AP MLDs using a link for a particular TID, but not to directly control the traffic level.

Access control approaches may have undesirable impacts on non-AP MLDs. For example, consider a non-AP MLD that has the capability to operate two links simultaneously. One link may be 2.4 GHz; the non-AP MLD may switch the other link between 5 GHz and 6 GHz. If 2.4 GHz is performing poorly (e.g., so congested that it is not usable even for best effort (BE) traffic such as photo upload, web browsing, etc.), then the non-AP MLD may seek to use the other link for all traffic. For instance, if the non-AP MLD has concurrent BE and voice (VO)/video (VI) traffic, the non-AP MLD may use the other link for all traffic. If all links are allowed for all TIDs, the non-AP MLD may select either the 5 or 6 GHz link, as desired. However, if BE traffic is not allowed on the 6 GHz link (e.g., according to an EAT2LS mapping), the non-AP MLD may experience problems if the 5 GHz link becomes congested. For example, as long as the 5 GHz link is not congested, the non-AP MLD's quality of service (QoS) may be fine by operating on 5 GHz. If the 5 GHz link becomes congested, the non-AP MLD may keep the VO/VI on the 6 GHz link, e.g., to maintain acceptable QoS of VO/VI traffic. However, since BE is not allowed on 6 GHz, the non-AP MLD may choose between 1) switching between 5 GHz for BE traffic and 6 GHz for VO/VI traffic or 2) using the poor performing 2.4 GHz link for the BE traffic (e.g., resulting in a poor user experience). According to option 1), such frequent transitions between 5 GHz and 6 GHz links may not be a desired behavior. For example, it may take a significant amount of time to switch between these links, thus making it difficult for the non-AP MLD to meet QoS (e.g., latency) targets for the VO/VI traffic. Similarly, switching links may lead to high levels of energy use and/or increased probability of transmission or reception errors. Still further, there may be other reasons (e.g., related to coexistence interference, device to device (D2D) communication, operation of other RATs, etc.) that it may be preferable to the non-AP MLD to use the 6 GHz link only.

Meanwhile, latency sensitive applications may typically not be bandwidth hungry, e.g., with some potential exceptions such as virtual reality and/or augmented reality applications with Gbps-level raw data. Accordingly, there may be a waste of spectrum if the AP MLD only uses access control to limit types of traffic on a link. In other words, using the example above, if a 6 GHz link is reserved for VO/VI traffic only, there may be significant available spectrum for other traffic types (e.g., BE) if permitted by access control.

In some embodiments, rather than limiting the means of load balancing to access control, an AP MLD may attempt to manage load more directly. For example, to do so, the AP MLD may consider how much percentage of the airtime other types of traffic can occupy without disturbing the latency sensitive streams (e.g., VO/VI). Mathematically, traffic load may be considered as a function of the number of active STAs (e.g., including non-AP MLDs) and the average load per STA. Similarly, this may be considered as a function of the number of active STAs and the average airtime per STA. Said differently, the traffic load may be the sum of the loads of the STAs. Therefore, as an alternative to (and/or in addition to) reducing the number of active STAs via admission control, the AP MLD may reduce the load or airtime for one or more active STAs. This may be preferred, e.g., by the STA, if the STA does not have a good option to switch between links. Thus, a flexible approach to managing traffic of different links (e.g., by controlling how much, how long, when, etc. a non-AP MLD may transmit) may provide a means for the AP MLD to more directly manage load on a link while also allowing a non-AP MLD to have some options to use a preferred link. For example, if an EAT2LS mapping is used, the AP MLD may allow various exceptions or flexible use of links for other types of traffic on a link (e.g., in addition to those types of traffic that are prioritized for the link by the EAT2LS mapping). The AP MLD may attempt to provide guidelines for reasonable exceptions, e.g., that maintain QoS targets for the (e.g., latency sensitive) TIDs that are prioritized for a link.

Embodiments described herein provide systems, methods, and mechanisms for AP and non-AP MLD to manage traffic flow of multiple links. For example, according to embodiments of FIG. 12, AP MLDs and non-AP MLDs may exchange various messages related to flexible link usage and mapping. Flexible link usage may allow the AP MLD to manage traffic of any number of STAs over the various links provided by the AP MLD while also allowing the non-AP MLD(s) to operate efficiently, e.g., by using links flexibly according to guidelines provided by the AP MLD.

Aspects of the method of FIG. 12 may be implemented by an AP MLD in communication with one or more non-AP MLD. The AP MLD and/or non-AP MLD may be as illustrated in and described with respect to various ones of the Figures herein, or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements. For example, one or more processors (or processing elements) (e.g., processor(s) 101, 204, 302, 402, 432, 434, 439, baseband processor(s), processor(s) associated with communication circuitry such as 130, 230, 232, 329, 330, 430, etc., among various possibilities) may cause a wireless device, STA, UE, non-AP MLD, and/or AP MLD, or other device to perform such method elements.

Note that while at least some elements of the method of FIG. 12 are described in a manner relating to the use of communication techniques and/or features associated with IEEE and/or 802.11 (e.g., 802.11be) specification documents, such description is not intended to be limiting to the disclosure, and aspects of the method of FIG. 12 may be used in any suitable wireless communication system, as desired. Similarly, while elements of the method of FIG. 12 are described in a manner relating to non-AP MLDs, such description is not intended to be limiting to the disclosure, and aspects of the method of FIG. 12 may be used by STAs that are not MLDs, as desired.

The methods shown may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

A non-AP MLD 106 and an AP MLD 112 may establish communication (1202), according to some embodiments. For example, the AP MLD may provide one or more links (e.g., via one or more affiliated APs) and the non-AP MLD may associate with the AP MLD via at least one of the links.

The AP MLD may provide configuration information to the non-AP MLD, e.g., related to use of the various links. For example, the AP MLD may indicate a link mapping for use by the non-AP MLD. For example, the AP MLD may indicate which TID(s) the non-AP MLD should map to which links. The mapping may be a default mapping or may be specific to the non-AP MLD (e.g., the AP MLD may communicate with different non-AP MLDs using the same or different mappings). For example, the AP MLD may indicate a link mapping previously used with a particular non-AP MLD, etc. The mapping may be an AT2AL, AT2LS, EAT2LS, and/or flexible mapping (e.g., as further discussed herein with respect to FIGS. 9-11 and 14), among various possibilities.

The configuration information may include information such as identification of the AP MLD and/or network (e.g., SSID, etc.). Some configuration information may be related to link mapping and usage; other configuration information may be related to other subjects.

The AP MLD may provide the configuration information via a beacon or other message. For example, the AP MLD may broadcast a default mapping in a beacon to all STAs in communicative range of the AP MLD or to all STAs associated with the AP MLD. The AP MLD may transmit individual configuration information, such as mappings, via individual beacons or messages.

In some embodiments, the configuration information may include an indication of whether a mapping is flexible and/or whether guidelines for the mapping are (and/or will be) provided. Guidelines/policies for flexible link usage are further discussed below with respect to 1208. However, it will be appreciated that such guidelines may be determined at any time, e.g., including prior to and/or concurrently with establishing communication and/or at any later time(s). For example, the AP MLD may determine flexible usage policies based on current and/or past traffic flows (e.g., of any number of STAs/non-AP MLDs associated with the AP MLD) on the various links, policies established for other STAs/non-AP MLDs, number of STAs/non-AP MLDs associated, etc. Thus, in some embodiments, such guidelines or information about flexible mapping may be provided at any time, e.g., including at the time of establishing communication and/or in beacons broadcast to multiple STAs. In some embodiments, an indication may be provided that guidelines will be provided at a later time. In some embodiments, flexible usage policies may be set by default or otherwise known by both devices (e.g., due to being set in an 802.11 or other communication standard, etc.), and thus no indication of such policies may be transmitted.

In some embodiments, the AP MLD may request information about the capabilities and/or preferences of the non-AP MLD related to usage of flexible mapping. The non-AP MLD may provide the requested information. For example, the AP MLD may request and the non-AP MLD may provide an indication of what link(s) it can or cannot operate simultaneously (e.g., due to hardware limitations and/or coexistence interference), how long it takes to switch between various links or combinations of links, etc.

The non-AP MLD may determine information related to its preferences for link usage (1204), according to some embodiments. For example, the non-AP MLD may determine a requested usage of any link(s) for any TID(s) that is/are not allowed/prioritized for the link(s) according to the mapping.

The requested usage may be a traffic load (e.g., an amount of data, amount of transmission time (e.g., transmission opportunity (TXOP) or airtime), and/or a level of throughput (e.g., bits per time unit)) and/or a duty cycle (e.g., a service frequency or other measure of interval between transmissions), etc.

The requested usage may be based on any combination of an expected and/or current amount of traffic for the TID(s), expected and/or current traffic pattern(s) (e.g., time interval between transmissions, length of transmission(s), etc.) for the TID(s), expected and/or current amount of traffic for any other TID(s), expected and/or current traffic pattern(s) for any other TID(s), current and/or past measurement of the link(s) associated with requested usage, current and/or past measurement of any other link(s), ability of the non-AP MLD to switch between link(s) (e.g., quickly enough to support traffic of the TID(s)), interference between the links, costs (e.g., energy use) of such switching, and/or other factors. For example, the non-AP MLD may determine a requested usage for a non-prioritized TID that allows traffic of the non-prioritized TID to be transmitted with (e.g., immediately before or after or concurrently with) traffic of a TID prioritized for that link, thus avoiding or reducing link switching. As another example, based on one or more measurement of the link being sufficiently better (e.g., in terms of interference, signal strength, etc., and possibly in view of thresholds for either/both links or the difference between the links) than an alternative link, the non-AP MLD may determine a requested usage to shift enough traffic of the TID to the link (e.g., for which the TID is not prioritized) to meet a quality of service (QoS) target for the TID. As another example, the non-AP MLD may determine a requested usage that allows for exchange of a particular amount of data (e.g., per time period) for the non-prioritized TID, thus avoiding the energy/time cost of a link switch for an amount of data below a threshold. The non-AP MLD may determine the requested usage in a manner that attempts to avoid overburdening the link, e.g., with traffic of the non-prioritized TID.

The non-AP MLD may determine the requested usage in response to a request from the AP MLD, in response to a change in mapping, in response to a change in traffic (e.g., and/or any of the factors for determining requested usage discussed above), in response to establishing communication, or periodically (e.g., at each beacon interval, number of beacon intervals, or other period), etc.

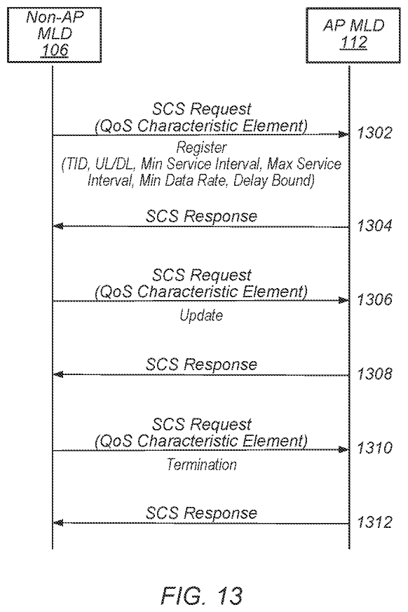

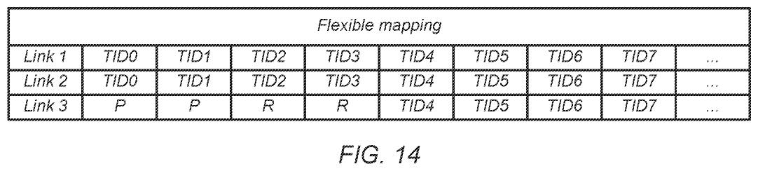

The non-AP MLD may indicate the requested usage to the AP MLD (1206), according to some embodiments. The non-AP MLD may provide the indication in a message to the AP MLD along with other information and/or in an individual message. For example, the non-AP MLD may use a stream classification service (SCS) handshake to indicate that a TID is a priority TID (see, e.g., FIG. 13). For example, a QoS characteristic element may describe the service frequency (e.g., how often the non-AP MLD requests to transmit data of the TID), traffic load (e.g., transmission time per interval, etc.), and/or other information about the requested usage. Similarly, the non-AP MLD may provide information such as a report on the amount of buffered traffic for the TID, and/or other indication of expected load, etc.

The AP MLD may determine a mapping and/or flexible usage guidelines/policy (1208), according to some embodiments. In some embodiments, the AP MLD may determine a new/modified mapping (e.g., relative to a mapping used previously, e.g., in 1202 and/or at a previous time interval). Alternatively, the AP MLD may determine new/modified policy and/or flexible usage guidelines for a current mapping, e.g., that is already in use. In some embodiments, the AP MLD may determine not to change the policy and/or flexible usage guidelines for a current mapping.

The AP MLD may determine one or more factors related to load balancing. For example, the AP MLD may determine current and/or expected load on one or more links and may compare the load to a maximum throughput for the respective link(s). The AP MLD may determine expected load based on current and/or past load, with anticipated changes (e.g., due to newly associating STAs/non-AP MLDs, information provided by any STAs/non-AP MLDs (e.g., in 1202 and/or 1206), compliance of one or more STAs/non-AP MLDs with prior policy/guidelines (e.g., as discussed below with respect to 1214), etc. Similarly, the AP MLD may determine performance of the link(s) and/or TID(s), e.g., what fraction of traffic for various links, TIDs, or combinations thereof is meeting performance targets (e.g., latency, throughput, etc.). As another example, the AP MLD may determine the acceptable (e.g., on average) number/proportion of TXOPs from the non-AP MLDs that may be used for transmitting low-priority TIDs. In other words, the AP MLD may determine a fraction of transmission time that may be used by one or more (e.g., potentially all of the associated) non-AP MLDs/STAs that can be used for non-prioritized traffic, e.g., without resulting in excessive negative impact to traffic of the prioritized traffic. For example, the AP MLD may determine a maximum level or percentage of time that may be used for non-prioritized TIDs while still meeting applicable QoS targets for any prioritized TIDs on the link. This may be determined based on averaging recent past traffic of the prioritized TIDs or using a percentile or other measure based on a distribution, etc.

Based on the load balancing factor(s), the AP MLD may determine a mapping and/or associated flexible usage policy/guideline(s) for the non-AP MLD (and possibly any number of other STA/non-AP MLDs). The AP MLD may determine the mapping and policy/guidelines to attempt to distribute the load (e.g., of all associated STAs/non-AP MLDs) across all links, e.g., so that the traffic of the TIDs can be exchanged in view of the QoS characteristics of the various TIDs. Further, the AP MLD may determine the mapping and policy/guidelines based on known information about the constraints of the various STAs/non-AP MLDs. For example, the AP MLD may select a mapping and policy/guidelines that provides the non-AP MLD with the option of communicating according to the requested usage (e.g., of 1204/1206).

In some embodiments and/or circumstances, the AP MLD may select a mapping and policy/guidelines that does not provide one or more STA/non-AP MLD with the option of communicating according to a relevant requested usage (e.g., of 1204/1206). However, in such a case, the AP MLD may select a mapping and policy/guidelines that, if possible, provides some flexibility to the non-AP MLD to manage traffic of one or more TIDs between on or more links. In other words, the AP MLD attempt to select a mapping and policy/guidelines that allows the non-AP MLD to manage its own traffic efficiently while not overburdening any link of the AP MLD.

The mapping and policy/guidelines may provide that different links may be used in one of at least the following basic ways: without restriction (e.g., any TID may be considered prioritized or fully allowed for that link), with some restriction (e.g., traffic of a particular TID on that link may be allowed with some limitation/guideline), or not at all (e.g., the non-AP MLD may not transmit traffic of that TID on that link, e.g., for the time period that the guideline is in effect, that TID may be prohibited from that link). Thus, the mapping may describe each link according to one of these three options (see, e.g., FIG. 14). It will be appreciated that different TIDs may have different rules/guidelines for the same link and/or that the same TID may have different rules/guidelines for different links. Some guidelines may apply to a link without regard to TID (e.g., a total transmission limit for any combination of TIDs, etc.) In other words, a guideline may be specific to a particular link/TID combination or to a particular link (e.g., without regard to any particular TID(s), but instead for all TIDs taken together). For example, a first guideline for use of a first link may apply to traffic of a first TID but not to traffic of a second TID.

For a TID that is allowed use of a link with some restriction, the guideline/rule for use of the link may be in any of various forms.

As one possibility, a guideline for use of a link may be a maximum amount of transmission time per time interval. Such a maximum amount of transmission time may be applied as a total (e.g., without regard for TID) or for traffic of a particular TID(s)). The time interval may be a beacon interval (e.g., the time from one beacon of the AP MLD to the next) or a number of consecutive beacon intervals, among various possibilities. In some embodiments, different time intervals may be used, including time intervals shorter than a beacon interval. Further, different transmission time limits may be used for different time intervals. For example, a guideline may provide a first maximum transmission time limit for a first half of a beacon interval and a different maximum transmission time limit for a second half of the beacon interval. Any number of maximum transmission time limits may be determined for different time intervals. A pattern of transmission time limits for a sequence of time intervals may be determined, e.g., alternating between higher and lower time limits, etc.

In some embodiments, a longer duration guideline may set a lower limit and a shorter duration guideline may set a higher (e.g., burst) limit. For example, a first guideline may set a lower limit for a long run average (e.g., not more than x ms per interval averaged over 100 intervals) and a second guideline may set a higher limit for a transmission burst (e.g., not more than y ms in any single interval).

In some embodiments, the AP MLD may use such time guidelines in a manner similar to time division multiple access (TDMA). For example, a first non-AP MLD may be allowed to use a first time (e.g., within a longer time interval) for transmissions of a non-prioritized TID, a second non-AP MLD may be allowed to use a second time (e.g., within the longer interval) for transmissions of a non-prioritized TID, etc. In this manner, the AP MLD may reserve some time(s) for traffic of unrestricted TIDs and divide other time(s) among multiple non-AP MLDs for use of their non-prioritized TID(s) or may otherwise limit the number of non-AP MLDs using any particular time(s) for non-prioritized TID(s) as desired.

As another possibility, a guideline for use of a link may be a subset of frequencies of the link that may be used for traffic of the TID. Similarly, a guideline for use of a link may be a subset of times of a particular time interval that the link that may be used for traffic of the TID.

In some embodiments, the AP MLD may use frequency guidelines in a manner similar to frequency division multiple access (FDMA). For example, a first non-AP MLD may be allowed to use a first frequency range for transmissions of a non-prioritized TID, a second non-AP MLD may be allowed to use a second frequency range for transmissions of a non-prioritized TID, etc. In this manner, the AP MLD may reserve some bandwidth or frequency range(s) for traffic of unrestricted TIDs and divide other bandwidth/frequency among multiple non-AP MLDs for use of their non-prioritized TID(s) or may otherwise limit the number of non-AP MLDs using any particular frequency for non-prioritized TID(s) as desired.

As another possibility, a guideline for use of a link may specify that the non-AP MLD may transmit traffic of the TID in response to a trigger, e.g., such as an 802.11ax or similar trigger frame from the AP MLD. The AP MLD may determine what the non-AP MLD may consider to be a trigger and/or a guideline for how much and/or how long the non-AP MLD may transmit following the detection of a trigger. For example, a trigger may be a particular message or indication in a message from the AP MLD to the non-AP MLD, e.g., such as a trigger frame. A trigger frame or other explicit trigger from the AP MLD may further specify particular limits for the transmission, e.g., duration, frequency, size of a resource unit, etc. For example, the AP MLD may determine the allocated resource based on non-AP MLD's request.

Such an explicit trigger may be used by the AP MLD to manage traffic in real time. In other words, the AP MLD may use triggers to manage load and perform scheduling according to the network conditions. For example, in response to determining that the non-AP MLD has not transmitted traffic of the particular TID on the link for a threshold amount of time, the AP MLD may attempt to find a time when traffic (e.g., of all TIDs/STAs) on the link is below a threshold and provide a trigger to the non-AP MLD to transmit at that time. In some embodiments, such a trigger may be provided regardless of how much time has elapsed since a previous transmission (e.g., by the non-AP MLD of the particular TID on the link) and may be provided based only on traffic levels.

As another possibility, a guideline for use of a link may specify that the non-AP MLD may transmit traffic of the TID in association with traffic of a different TID (e.g., which may be allowed with or without restriction on the link). Thus, the non-AP MLD may be allowed to “piggyback” or combine traffic of the TID with traffic of a different TID that is permitted (e.g., for a different reason). Such a transmission of traffic of the TID with traffic of the other TID may be subject to limitation on the length or amount of traffic transmitted.

These guidelines may be combined in any way desired. For example, different guidelines may be used at different times (e.g., during a first time interval, the non-AP MLD may transmit for a first amount of time (e.g., without restriction on the particular time or frequency); during a second time interval, the non-AP MLD may transmit during only a particular set of times; during a third time interval, the non-AP MLD may transmit only on a particular frequency range; etc.). Similarly, in response to detecting a trigger of one type, the non-AP MLD may transmit on a first frequency range and in response to detecting a trigger of a second type, the non-AP MLD may transmit at a particular time. It will be appreciated that numerous other examples are possible. Further, the AP MLD may use a combination of limitations similar to FDMA and TDMA to restrict the time and frequencies used for non-prioritized TIDs.

In some embodiments, the mapping and/or flexible usage policy/guidelines may be specific to uplink and/or downlink traffic (e.g., uplink and downlink traffic may have different mapping and/or guidelines). In some embodiments, usage policy/guidelines may only be determined in advance for uplink traffic (e.g., transmitted by the non-AP MLD). The AP MLD may determine what link(s) to use for downlink traffic in real time.

It will be appreciated that the AP MLD may determine the mapping and/or flexible usage policy/guidelines without input from the non-AP MLD, according to some embodiments. Thus, 1204 and 1206 may be omitted.

The AP MLD may transmit an indication of the mapping and/or flexible usage policy/guidelines to the non-AP MLD (possibly any number of non-AP MLDs, e.g., for which the mapping/policies/guidelines may be the same or different) (1210), according to some embodiments.

The indication may be transmitted in any message or messages, e.g., using any combination of one or more fields. For example, such indication may be carried in a beacon frame as an Information Element (IE), a (e.g., new) management frame, and/or a (e.g., new) A-Control field in the MAC header of a DL frame, among various possibilities. In other words, the indication may be transmitted or broadcast in a beacon, transmitted to the non-AP MLD in a management frame, or (e.g., along with data) in a downlink frame.

The indication may be transmitted periodically (e.g., in or associated with each beacon or set of beacons, etc.). The mapping and/or policy/guideline(s) may be updated periodically (e.g., for each beacon interval).

Alternatively, the mapping and guideline may be determined and transmitted in response to receiving the requested usage from the non-AP MLD (e.g., in 1206) or in response to detecting a change in conditions (e.g., any of the load balancing factors discussed with respect to 1208, etc.).

The non-AP MLD may receive the indication. The non-AP MLD may implement any changes to the mapping and policy/guidelines. For example, the non-AP MLD may change how it buffers traffic of different TIDs for different links.

The non-AP MLD and AP MLD may exchange data according to the mapping and/or flexible usage policy/guidelines (1212), according to some embodiments. For example, the non-AP MLD may transmit data of one or more TIDs to the AP MLD using one or more links. Data of any TID that is transmitted on a link with an applicable flexible usage policy/guideline may be transmitted as allowed by that policy/guideline. For example, the non-AP MLD may transmit data of the TID at the time, frequency, and/or amount/duration allowed by the guidelines.

To the extent that the non-AP MLD has additional traffic of the TID to transmit, it may do so according to one or more of the following options: 1) it may transmit the traffic on a different link (e.g., where that TID is allowed without restriction or subject to any applicable guideline on that link); 2) it may transmit the traffic during a subsequent time interval (e.g., on the same or different link); and/or 3) it may drop (e.g., not transmit) the traffic. For example, consider a non-AP MLD with 100 units of data to transmit for a TID which is allowed without restriction on links 1 and 2, but allowed with restriction on link 3. If the non-AP MLD prefers to transmit data of this TID on link 3 (e.g., to avoid switching back and forth between links 2 and 3, which may use common hardware), it may attempt to transmit as much of the 100 units as possible (e.g., subject to the applicable guidelines) during the time interval. For example, the non-AP MLD may determine that 50 units of data may be transmitted on link 3 subject to the guidelines and may select 50 of the units (e.g., selected according to urgency or other factors) to transmit on link 3. The non-AP MLD may then determine whether to attempt to transmit some or all of the remaining 50 units on link 1, switch (e.g., for part of the time interval) to link 2 to transmit some or all of the remaining 50 units on link 2, delay some or all of the remaining 50 units for a subsequent time interval (e.g., to attempt to transmit on link 3 at that time), and/or to drop some or all of the remaining 50 units.

In some embodiments, the non-AP MLD may determine to exceed the limits for transmission of an applicable guideline, e.g., under certain circumstances. For example, the non-AP MLD may determine to transmit in excess of the guideline based on factors such as: the amount of excess transmission being below a threshold (e.g., in units of time, data, bandwidth, etc.), that no other link(s) is a viable option for transmitting the data within QoS requirements of the TID, and/or an amount of time since a previous instance of violating an applicable guideline.

The AP MLD may receive the traffic transmitted by the non-AP MLD, e.g., on the various links.

The AP MLD may determine whether (or the extent to which) the non-AP MLD has complied with the mapping and/or flexible usage policy/guidelines (1214), according to some embodiments. For example, if the AP MLD determines that an amount, timing, or frequency of transmission from the non-AP MLD does not comply with the applicable guidelines, the AP MLD may determine how much or how often the non-AP MLD has not complied. The AP MLD may determine one or more response to any non-compliance. Such a response may be determined in conjunction with determining a new/updated mapping and/or flexible usage policy/guideline(s) in 1208.

In the event that the AP MLD determines that a non-AP MLD has not complied, it may determine how/if to adjust the mapping and policy/guidelines or otherwise how to handle the non-compliance. For example, in cases of minor and/or rare non-compliance by a particular non-AP MLD, the AP MLD may determine not to respond to the non-compliance. Rare non-compliance may be if there are fewer than a threshold number of non-compliance events over a number of time periods by the particular non-AP MLD, etc. Minor non-compliance may be if the amount (e.g., or duration, bandwidth, etc.) of data transmitted in excess of the guideline is less than a threshold.

Alternatively, the AP MLD may determine (e.g., in the case that the non-compliance is considered justified, e.g., if the non-AP MLD had no viable alternative for transmitting the data within QoS requirements), the AP MLD may attempt (e.g., in 1208) to modify the mapping and/or policy/guidelines to better accommodate the non-AP MLD.

In the event that the AP MLD determines that the non-compliance is significant and/or repeated (and possibly also that the non-compliance is not justified), the AP MLD may determine to adjust the access of the non-AP MLD. This may allow the AP MLD to manage load on the various links, e.g., to protect other STAs/non-AP MLDs from excessive non-compliance by the non-AP MLD. For example, the AP MLD may determine (e.g., in 1208) to use a mapping that provides less flexibility to the non-AP MLD. For example, the non-AP MLD may be prohibited from using a link, e.g., at least for one or more TID (e.g., a TID/link combination for which the non-AP MLD has repeatedly and/or significantly exceeded/violated guideline usage).

In some embodiments, the AP MLD may determine to block a non-AP MLD from associating with the AP MLD completely, e.g., in response to a determination that the amount and/or frequency of non-compliance exceeds a relevant threshold. For example, thresholds for disassociating with a non-AP MLD may be higher than thresholds for adjusting access of the non-AP MLD. Thus, the AP MLD may apply progressively stronger restrictions on a non-compliant non-AP MLD. For example, at a first instance of non-compliance, the AP MLD may attempt to adjust policy/mapping to provide more flexibility to a non-AP MLD. At a later instance of non-compliance, the AP MLD may attempt to adjust policy/mapping to provide more protection for other STAs/non-AP MLDs (e.g., and more restriction for the non-compliant non-AP MLD). At a later instance of non-compliance, the AP MLD may block the non-AP MLD completely.

Following the exchange of data (e.g., in 1212), the non-AP MLD may determine its buffer status and/or whether the non-AP MLD was able to transmit all desired data on appropriate link(s) during the time interval (1216), according to some embodiments. For example, the non-AP MLD may determine how much (if any) data remains in its transmission buffers associated with one or more TID or link that was not transmitted. In other words, the non-AP MLD may determine the extent to which the mapping and/or flexible usage guideline/policy did not allow the non-AP MLD to transmit at least some data. The non-AP MLD may use this information, as well as other factors discussed above to determine a requested usage (e.g., in 1204). For example, the non-AP MLD may (e.g., in 1206) indicate to the AP MLD the amount of data that was not transmitted. Similarly, the non-AP MLD may indicate one or more suggested changes to the mapping and/or policy/guidelines to allow the non-AP MLD to transmit more of the data.

### FIGS. 13-14 and Additional Information.

The method of FIG. 12 may allow flexible load management approach that may be considered a middle ground between an AT2AL mapping (e.g., which allows for little or no load balancing control for the AP MLD, but provides high flexibility to the non-AP MLD) and an EAT2LS mapping (e.g., which allows the AP MLD to control the number of non-AP MLDs using a link (for a particular TID), but does not allow the non-AP MLD to transmit any traffic (of the TID) on the link). The method of FIG. 12 allows the AP MLD (e.g., with or without input from the non-AP MLD) to manage/limit a non-AP MLD's airtime/load on the link.

For example, with an AT2AL mapping, the AP MLD may use a guideline to suggest maximum transmission time (e.g., per beacon interval), no matter what traffic is sent by the non-AP MLD during this transmission time. Thus, the guideline may state a maximum time (e.g., transmission not to exceed x ms per y ms interval, etc.), and the non-AP MLD may divide the maximum time between any combination of TIDs. Such a maximum may be updated through beacon or other message.

As another example, with an EAT2LS mapping, the AP MLD may suggest a maximum transmission time for those TIDs that are not prioritized on a link (e.g., non-prioritized traffic). For example, if a 6 GHz link only allows (e.g., without restriction) VO/VI traffic, the AP MLD may suggest BE (and/or background (BK)) traffic should not exceed a maximum (e.g., x ms per y ms interval) on the 6 GHz link. Such a maximum may be updated through beacon or other message.

In either example, if the non-AP MLD consistently and/or significantly violates the suggested maximum transmission time, the AP MLD may penalize (e.g., adjust the mapping and/or guidelines, or completely disassociate with) the non-AP MLD for social good, e.g., to allow other STAs reasonable access to the link.

In either example, the maximum transmission time may be suggested/requested by STA, but determined by the AP.

In some embodiments, the maximum transmission time may be greater than 0.

Besides transmission time for non-prioritized traffic, the AP may signal other types of parameters to limit such traffic without totally disallowing it. For example, TX frequencies, particular time opportunities, triggers, etc.

In some embodiments, aspects of the method of FIG. 12 may be performed in a different order than shown and/or may be repeated. For example, 1208 and/or 1210 may occur prior to 1204 and/or 1206, among various possibilities. For example, the AP MLD may initially or in general provide some flexible usage guidelines (e.g., in 1208, 1210, and/or 1202). Then, the non-AP MLD may determine whether the provided flexible usage guidelines are sufficient for its traffic, QoS requirements, limitations, etc. (e.g., in 1204). If the non-AP MLD determines that further flexibility is needed or beneficial, it may transmit an indication of such a request (e.g., in 1206). Then, the AP MLD may determine whether to update/modify the mapping and/or flexible usage guidelines and transmit any update (or indication that no change is made) (e.g., in a second instance of 1208/1210). In other words, the AP MLD may initially allow for some exceptions to a mapping and may consider changing/expanding those exceptions (as well as the mapping) in response to a request from the non-AP MLD.

In some embodiments, the method of FIG. 12 may allow for scheduled assistance from for non-prioritized traffic (e.g., on restricted links). For example, if the AP would like to control the medium access rather than let a non-AP MLD initiate its own transmission of non-prioritized traffic, the AP MLD may set a guideline for use of triggers. The non-AP MLD may inform the AP its necessary service frequency and traffic load of non-prioritized traffic, e.g., using SCS procedure with QoS characteristics element. The AP-MLD may then schedule triggered uplink access or set up other types of service periods specifically targeted for the non-prioritized traffic considering the available resource.

FIG. 13 illustrates example stream classification service (SCS) handshakes, according to some embodiments. As shown, 3 different types of SCS handshakes may be used, e.g., to register, update, or terminate priority TID.

To register a priority TID, the non-AP MLD may send an SCS request to the AP MLD (1302), according to some embodiments. The request may include a quality of service (QoS) characteristic element. The QoS characteristic element may describe the TID, e.g., using a TID identifier, an indication of uplink or downlink, an indication of a minimum and/or maximum service interval (e.g., to describe intervals between packets, e.g., of periodic traffic. For example, each period, the application may generate one or a batch of packets, and then may pause until next period), a minimum data rate, and/or a delay bound (e.g., latency). The AP MLD may transmit a response (e.g., acknowledgement) (1304), according to some embodiments.

To update a priority TID, the non-AP MLD may send an SCS request to the AP MLD (1306), according to some embodiments. The request may include a QoS characteristic element and an indication that the registration of the priority TID is to be updated. The QoS characteristic element may describe the updated aspect of the TID. The AP MLD may transmit a response (e.g., acknowledgement) (1308), according to some embodiments.

To deactivate/terminate a priority TID, the non-AP MLD may send an SCS request to the AP MLD (1310), according to some embodiments. The request may include a QoS characteristic element and an indication that the registration of the priority TID is to be canceled. The QoS characteristic element may identify the TID. The AP MLD may transmit a response (e.g., acknowledgement) (1312), according to some embodiments.

FIG. 14 illustrates an example of a flexible mapping, according to some embodiments. As shown, all TIDs (e.g., 0-7) may be allowed/prioritized without restriction on links 1 and 2. TIDs 4-7 may further be allowed and prioritized without restriction on link 3. TIDs 2 and 3 may be allowed, but not prioritized on link 3. In other words, these TIDs may be allowed on these links with restrictions (e.g., indicated by “R”). For example, use of these links may be subject to one or more guidelines, rules, or other limitations, as discussed above. TIDs 0 and 1 may be prohibited (e.g., indicate by “P”) on link 3. Thus, the non-AP MLD may not be permitted to use this link for exchanging traffic of these TIDs. A flexible mapping may be used at any time, e.g., as an initial mapping in 1202 and/or a modified/new mapping in 1210. It will be appreciated that the mapping shown in FIG. 14 is one of many possible examples. For instance, flexible mappings may be based on AT2AL mappings, AT2LS mappings, and/or EAT2LS mappings. In other words, a flexible mapping may be established with any combination of links and TIDs allowed without restriction, allowed with restriction, and/or prohibited.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

In one set of embodiments, a method may comprise: at an access point (AP) multi-link device (MLD) (AP MLD): providing a plurality of links; establishing communication with a non-access point MLD (non-AP MLD) according to a first mapping between a plurality of traffic identifiers (TIDs) and the plurality of links, the first mapping specifying that respective TIDs of the plurality of TIDs are mapped to at least respective subsets of the plurality of links; transmitting, to the non-AP MLD, an indication of a first guideline for use of a first link of the plurality of links; performing an exchange of data with the non-AP MLD using the first link of the plurality of links; and determining whether the exchange of data is consistent with the first guideline for use of the first link of the plurality of links.

In some embodiments, the exchange may be transmitting to the non-AP MLD and/or receiving from the non-AP MLD. The exchange need not be both transmitting and receiving.

In some embodiments, the method may further comprise, in response to determining that the exchange of data is not consistent with the first guideline for use of the first link of the plurality of links, limiting use of the first link of the plurality of links by the non-AP MLD.

In some embodiments, said limiting use of the first link of the plurality of links by the non-AP MLD comprises disassociating with the non-AP MLD.

In some embodiments, said limiting use of the first link of the plurality of links by the non-AP MLD comprises prohibiting the non-AP MLD from further use of the first link of the plurality of links for at least a first TID of the plurality of TIDs.

In some embodiments, the first guideline for use of the first link of the plurality of links comprises a maximum transmission time per time interval.

In some embodiments, the time interval comprises a beacon interval and the method further comprises: transmitting respective indications of respective maximum transmission times for respective beacon intervals.

In some embodiments, the first guideline for use of the first link of the plurality of links is applied to traffic of a first TID of the plurality of TIDs but not to traffic of a second TID of the plurality of TIDs.

In some embodiments, according to the first mapping: the first TID of the plurality of TIDs is mapped to a subset of the plurality of TIDs that does not include the first link; and the second TID of the plurality of TIDs is mapped to either: a subset of the plurality of TIDs that does include the first link; or all TIDs of the plurality of TIDs.

In some embodiments, the first TID of the plurality of TIDs is mapped to a subset of the plurality of links that does not include the first link; and the second TID of the plurality of TIDs is mapped to either: a subset of the plurality of links that does include the first link; or all links of the plurality of links.

In some embodiments, the first guideline for use of the first link of the plurality of links comprises a subset of frequencies of the first link of the plurality of links that may be used for traffic of any TID of the plurality of TIDs.

In some embodiments, the method may further comprise, determining at least one load balancing factor; and determining the first guideline for use of the first link of the plurality of links based on the at least one load balancing factor.

In some embodiments, the first guideline for use of the first link of the plurality of links is applied to traffic of all TIDs of the plurality of TIDs.

In one set of embodiments, a method may comprise: at a non-access point (AP) multi-link device (MLD) (non-AP MLD): associate, with an AP MLD, using a first mapping between a plurality of traffic identifiers and a plurality of links, wherein the plurality of links comprises different links connecting the AP MLD and the non-AP MLD; receive, from the AP MLD, an indication of a first rule for use of a first link of the plurality of links; and exchange data with the AP MLD using the first link of the plurality of links according to the first rule for use of the first link of the plurality of links.

In some embodiments, to exchange data with the AP MLD using the first link of the plurality of links according to the first rule for use of the first link of the plurality of links the method further comprises: buffer uplink traffic of a first traffic identifier; receive, from the AP MLD, a trigger for transmission on the first link of the plurality of links; and transmit, to the AP MLD on the first link of the plurality of links, the uplink traffic of the first traffic identifier in response to receiving the trigger for transmission on the first link of the plurality of links.

In some embodiments, to exchange data with the AP MLD using the first link of the plurality of links according to the first rule for use of the first link of the plurality of links the method further comprises: determine a first service period for the first link of the plurality of links according to the first rule for use of the first link of the plurality of links, wherein, according to the first rule for use of the first link of the plurality of links: during the first service period, traffic of a first traffic identifier may be transmitted by the non-AP MLD on the first link; and during at least one time outside of the first service period, traffic of the first traffic identifier may not be transmitted by the non-AP MLD on the first link; prior to the first service period, buffer uplink traffic of the first traffic identifier; and during the first service period, transmit the uplink traffic of the first traffic identifier to the AP MLD on the first link of the plurality of links.

In some embodiments, the method further comprises: determine that, according to the first mapping, at least one traffic identifier of the plurality of traffic identifiers is not prioritized for the first link of the plurality of links; determine a requested usage of the first link of the plurality of links for the at least one traffic identifier of the plurality of traffic identifiers; and transmit an indication of the requested usage to the AP MLD.

In some embodiments, the requested usage comprises at least one of: a service frequency; or a traffic load.

In some embodiments, the indication of the requested usage comprises a stream classification service (SCS) request.

In one set of embodiments, a method at an access point (AP) multi-link device (MLD) (AP MLD), may comprise: establish communication with a non-AP MLD; transmit, to the non-AP MLD, an indication of a mapping between a plurality of links and a plurality of traffic flows; and transmit, to the non-AP MLD, an indication of a flexible usage policy for at least one link of the plurality of links.

In some embodiments, the flexible usage policy comprises a limitation on a maximum transmission time for a total of any transmissions of any traffic flows of the plurality of traffic flows. For example, a total of transmission time (e.g., within a specified time window) of all traffic flows may be calculated and compared to the maximum transmission time. For example, a sum total transmission time of the transmissions comprising the plurality of traffic flows may be limited according to the flexible usage policy.

In some embodiments, the flexible usage policy comprises a limitation on a maximum transmission time for a total of any transmissions of one or more non-prioritized traffic flow of the plurality of traffic flows. For example, a total of transmission time (e.g., within a specified time window) of all non-prioritized traffic flows may be calculated and compared to the maximum transmission time. For example, a sum total transmission time of the transmissions comprising non-prioritized traffic flows of the plurality of traffic flows may be limited according to the flexible usage policy.

Any of the methods described herein for operating an AP MLD may be the basis of a corresponding method for operating a non-AP MLD and vice versa, e.g., by interpreting each message/signal X received by the non-AP MLD in the DL as message/signal X transmitted by the AP MLD, and each message/signal Y transmitted in the UL by the non-AP MLD as a message/signal Y received by the AP MLD. Moreover, a method described with respect to an AP MLD may be interpreted as a method for a non-AP MLD in a similar manner.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a wireless device may be configured to include a processor (and/or a set of processors) and a memory medium, where the memory medium stores program instructions, where the processor is configured to read and execute the program instructions from the memory medium, where the program instructions are executable to cause the wireless device to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method, comprising:
at an access point (AP) multi-link device (MLD) (AP MLD):
providing a plurality of links;
establishing communication with a non-access point MLD (non-AP MLD) according to a first mapping between a plurality of traffic identifiers (TIDs) and the plurality of links, the first mapping specifying that respective TIDs of the plurality of TIDs are mapped to at least respective subsets of the plurality of links;
transmitting, to the non-AP MLD, an indication of a first guideline for use of a first link of the plurality of links;
performing an exchange of data with the non-AP MLD using the first link; and
determining whether the exchange of data is consistent with the first guideline for use of the first link.

2. The method of claim 1, further comprising, in response to determining that the exchange of data is not consistent with the first guideline for use of the first link, limiting use of the first link by the non-AP MLD.

3. The method of claim 2, wherein said limiting use of the first link by the non-AP MLD comprises disassociating with the non-AP MLD.

4. The method of claim 2, wherein said limiting use of the first link by the non-AP MLD comprises prohibiting the non-AP MLD from further use of the first link for at least a first TID of the plurality of TIDs.

5. The method of claim 1, wherein the first guideline for use of the first link comprises a maximum transmission time per time interval.

6. The method of claim 5, wherein the time interval comprises a beacon interval and the method further comprises:
transmitting respective indications of respective maximum transmission times for respective beacon intervals.

7. The method of claim 1, wherein the first guideline for use of the first link is applied to traffic associated with a first TID of the plurality of TIDs but not to traffic associated with a second TID of the plurality of TIDs.

8. The method of claim 7, wherein, according to the first mapping:
the first TID of the plurality of TIDs is mapped to a subset of the plurality of links that does not include the first link; and
the second TID of the plurality of TIDs is mapped to either:
a subset of the plurality of links that includes the first link; or
all links of the plurality of links.

9. The method of claim 1, wherein the first guideline for use of the first link comprises a subset of frequencies of the first link that may be used for traffic of any TID of the plurality of TIDs.

10. The method of claim 1, further comprising:
determining at least one load balancing factor; and
determining the first guideline for use of the first link based on the at least one load balancing factor.

11. The method of claim 1, wherein the first guideline for use of the first link is applied to traffic of all TIDs of the plurality of TIDs.

12. An apparatus, comprising:
a processor configured to cause a non-access point (AP) multi-link device (MLD) (non-AP MLD) to:
associate, with an AP MLD, using a first mapping between a plurality of traffic identifiers and a plurality of links, wherein the plurality of links comprises at least two different links connecting the AP MLD and the non-AP MLD;
receive, from the AP MLD, an indication of a first rule for use of a first link of the plurality of links; and
exchange data with the AP MLD using the first link according to the first rule.

13. The apparatus of claim 12, wherein to exchange data with the AP MLD using the first link according to the first rule, the processor is further configured to cause the non-AP MLD to:
buffer uplink traffic associated with a first traffic identifier;
receive, from the AP MLD, a trigger for transmission on the first link; and
transmit, to the AP MLD on the first link in response to receiving the trigger for transmission on the first link, the uplink traffic associated with the first traffic identifier.

14. The apparatus of claim 12, wherein to exchange data with the AP MLD using the first link according to the first rule, the processor is further configured to cause the non-AP MLD to:
determine a first service period for the first link according to the first rule, wherein, according to the first rule:
during the first service period, traffic associated with a first traffic identifier may be transmitted by the non-AP MLD on the first link; and
during at least one time outside of the first service period, traffic associated with the first traffic identifier may not be transmitted by the non-AP MLD on the first link;
buffer, prior to the first service period, uplink traffic associated with the first traffic identifier; and
transmit, during the first service period, the uplink traffic associated with the first traffic identifier to the AP MLD on the first link.

15. The apparatus of claim 12, wherein the processor is further configured to cause the non-AP MLD to:
determine that, according to the first mapping, at least one traffic identifier of the plurality of traffic identifiers is not prioritized for the first link;
determine a requested usage of the first link for the at least one traffic identifier of the plurality of traffic identifiers; and
transmit an indication of the requested usage to the AP MLD.

16. The apparatus of claim 15, wherein the requested usage comprises at least one of:
a service frequency; or
a traffic load.

17. The apparatus of claim 15, wherein the indication of the requested usage comprises a stream classification service (SCS) request.

18. An access point (AP) multi-link device (MLD) (AP MLD), comprising:
a radio; and
a processor communicatively coupled to the radio and configured to cause the AP MLD to:
establish communication with a non-AP MLD;
transmit, to the non-AP MLD, an indication of a mapping between a plurality of links and a plurality of traffic flows; and
transmit, to the non-AP MLD, an indication of a flexible usage policy for at least one link of the plurality of links.

19. The AP MLD of claim 18, wherein the flexible usage policy comprises a limitation on a maximum transmission time for a total of any transmissions of any traffic flows of the plurality of traffic flows.

20. The AP MLD of claim 18, wherein the flexible usage policy comprises a limitation on a maximum transmission time for a total of any transmissions of one or more non-prioritized traffic flows of the plurality of traffic flows.
